(19) United States
(12) Patent Application Publication
(10) Pub. No.: US 2023/0272229 A1
(43) Pub. Date: Aug. 31, 2023

(54) THERMALLY INSULATING AND FIRE RETARDANT NON-INTUMESCENT COATING AND METHODS FOR MAKING SAME

(71) Applicant: ZEROIGNITION TECHNOLOGIES INC., Halifax (CA)

(72) Inventor: Eamonn Martin Blair, Halifax (CA)

(21) Appl. No.: 18/011,034

(22) PCT Filed: Jun. 18, 2021
(86) PCT No.: PCT/CA2021/050836

§ 371 Date: Dec. 16, 2022

Related U.S. Application Data
(60) Provisional application No. 63/041,129, filed on Jun. 19, 2020.

(51) Int. Cl. C09D 5/18; C08K 7/26; C09D 7/62; C09D 7/80

(52) U.S. Cl. CPC C09D 5/18; C08K 7/26; C09D 7/62; C09D 7/80

(57) ABSTRACT

A coating includes a polymeric resin lacking an intumescent material, a deconstructed nanoporous material, and solids of a fire-retarding solution. The deconstructed nanoporous material and the solids of the fire-retarding solution are incorporated into the polymeric resin to form a thermally-insulating, fire-retardant coating having a homogenous consistency. Methods of forming the coating are also disclosed.

### BACKGROUND

### Field of the Disclosure

The present disclosure relates to non-intumescent coatings and, more particularly to a thermally-insulating and fire retardant non-intumescent coating and methods for making such a non-intumescent coating.

### Description of Related Art

Conventional intumescent paints may offer some passive thermal protection, though generally only do so when exposed to heat in the range of 200 to 250 degrees Celsius (and intumesce). At ambient temperatures, neither intumescent nor non-intumescent paints act as a thermal barrier to a significant degree. That is, intumescent or non-intumescent paints generally do not provide any protection to the loss of heat through conduction or radiation, and thus do not provide a significant insulation value.

In addition, such intumescent paints may be required to be applied in several layers to attain the required thickness for the intumescent element to appropriately intumesce and function as a fire retardant in the event of exposure of the coated object to flame or elevated temperature. In attaining the required coating thickness, it is difficult to obtain a smooth surface finish with an intumescent paint. Without the intumescent element, the base resin of the paint is generally flammable.

As such, there exists a need for a thermally-insulating coating that, at ambient temperatures, will decrease the loss of heat therethrough due to radiation or conduction and reduce or prevent heat transfer, for example, due to thermal bridging. In the event of a fire, such a coating should also be fire-retardant (and/or heat resistant) to protect the underlying structure (coated object) from the fire/heat. Such a coating should also desirably provide the thermal insulation and fire/heat resistance properties in a relatively thin coating thickness, whether obtained through a single coat or multiple coats, and should result in a relatively smooth coating surface.

### SUMMARY

The above and other needs are met by aspects of the present disclosure which, in one aspect, provides a method of forming a coating, comprising adding a deconstructed nanoporous material and solids of a fire-retarding solution to a polymeric resin lacking an intumescent material to form a thermally-insulating, fire-retardant coating having a homogenous consistency.

Another aspect of the present disclosure provides a method of forming a coating, comprising combining a nanoporous material and a fire-retarding solution such that the nanoporous material absorbs the fire retarding solution; evaporating liquid from the nanoporous material having the fire-retarding solution absorbed therein such that a concentrate or solids thereof remain within the nanoporous material; and adding the nanoporous material having the concentrate or solids of the fire-retarding solution therein to a polymeric resin lacking an intumescent material to form a thermally-insulating, fire-retardant coating having a homogenous consistency.

Still another aspect of the present disclosure provides a coating, comprising a polymeric resin lacking an intumescent material; a deconstructed nanoporous material; and solids of a fire-retarding solution, wherein the deconstructed nanoporous material and the solids of the fire-retarding solution are incorporated into the polymeric resin to form a thermally-insulating, fire-retardant coating having a homogenous consistency.

The present disclosure thus includes, without limitation, the following embodiments:

### Embodiment 1

A method of forming a coating, comprising adding a deconstructed nanoporous material and solids of a fire-retarding solution to a polymeric resin lacking an intumescent material to form a thermally-insulating, fire-retardant coating having a homogenous consistency.

### Embodiment 2

The method of any preceding embodiment, or any combination of preceding embodiments, wherein adding the deconstructed nanoporous material and the solids of a fire-retarding solution to the polymeric resin comprises adding a deconstructed silica-based nanoporous material and the solids of the fire-retarding solution to the polymeric resin.

### Embodiment 3

The method of any preceding embodiment, or any combination of preceding embodiments, wherein adding the deconstructed nanoporous material and the solids of a fire-retarding solution to the polymeric resin comprises adding a deconstructed silica aerogel nanoporous material and the solids of the fire-retarding solution to the polymeric resin.

### Embodiment 4

The method of any preceding embodiment, or any combination of preceding embodiments, wherein adding the deconstructed nanoporous material and the solids of a fire-retarding solution to the polymeric resin comprises adding the deconstructed nanoporous material and the solids of the fire-retarding solution to a vinyl chloride resin, a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

### Embodiment 5

The method of any preceding embodiment, or any combination of preceding embodiments, comprising evaporating liquid from the fire-retarding solution to form the solids of the fire-retarding solution.

### Embodiment 6

The method of any preceding embodiment, or any combination of preceding embodiments, wherein evaporating liquid from the fire-retarding solution comprises spray drying the fire-retarding solution.

### Embodiment 7

The method of any preceding embodiment, or any combination of preceding embodiments, wherein evaporating liquid from the fire-retarding solution comprises evaporating liquid from the fire-retarding solution comprising a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

### Embodiment 8

The method of any preceding embodiment, or any combination of preceding embodiments, comprising treating the deconstructed nanoporous material to render the deconstructed nanoporous material hydrophilic, prior to adding the deconstructed nanoporous material and the solids of the fire-retarding solution to the polymeric resin.

### Embodiment 9

The method of any preceding embodiment, or any combination of preceding embodiments, comprising adding a surfactant, a thickener, a pigment, a fiber, or a combination thereof to the polymeric resin.

### Embodiment 10

A method of forming a coating, comprising combining a nanoporous material and a fire-retarding solution such that the nanoporous material absorbs the fire retarding solution; evaporating liquid from the nanoporous material having the fire-retarding solution absorbed therein such that a concentrate or solids thereof remain within the nanoporous material; and adding the nanoporous material having the concentrate or solids of the fire-retarding solution therein to a polymeric resin lacking an intumescent material to form a thermally-insulating, fire-retardant coating having a homogenous consistency.

### Embodiment 11

The method of any preceding embodiment, or any combination of preceding embodiments, wherein combining the nanoporous material and the fire-retarding solution comprises combining a silica-based nanoporous material and the fire-retarding solution.

### Embodiment 12

The method of any preceding embodiment, or any combination of preceding embodiments, wherein combining the nanoporous material and the fire-retarding solution comprises combining a silica aerogel nanoporous material and the fire-retarding solution.

### Embodiment 13

The method of any preceding embodiment, or any combination of preceding embodiments, wherein combining the nanoporous material and the fire-retarding solution comprises combining the nanoporous material and the fire-retarding solution comprising a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

### Embodiment 14

The method of any preceding embodiment, or any combination of preceding embodiments, wherein evaporating liquid from the nanoporous material having the fire-retarding solution absorbed therein comprises spray drying the fire-retarding solution.

### Embodiment 15

The method of any preceding embodiment, or any combination of preceding embodiments, comprising treating the nanoporous material to render the nanoporous material hydrophilic, prior to combining the nanoporous material and the fire-retarding solution.

### Embodiment 16

The method of any preceding embodiment, or any combination of preceding embodiments, wherein adding the nanoporous material having the concentrate or solids of the fire-retarding solution therein to a polymeric resin comprises adding the nanoporous material having the concentrate or solids of the fire-retarding solution therein to a vinyl chloride resin, a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

### Embodiment 17

The method of any preceding embodiment, or any combination of preceding embodiments, comprising adding a surfactant, a thickener, a pigment, a fiber, or a combination thereof to the polymeric resin.

### Embodiment 18

A coating, comprising a polymeric resin lacking an intumescent material; a deconstructed nanoporous material; and solids of a fire-retarding solution, the deconstructed nanoporous material and the solids of the fire-retarding solution being incorporated into the polymeric resin to form a thermally-insulating, fire-retardant coating having a homogenous consistency.

### Embodiment 19

The coating of any preceding embodiment, or any combination of preceding embodiments, wherein the deconstructed nanoporous material comprises a deconstructed silica-based nanoporous material.

### Embodiment 20

The coating of any preceding embodiment, or any combination of preceding embodiments, wherein the deconstructed nanoporous material comprises a deconstructed silica aerogel nanoporous material.

### Embodiment 21

The coating of any preceding embodiment, or any combination of preceding embodiments, wherein the solids of the fire-retarding solution are included within the deconstructed nanoporous material and result from evaporation of liquid from the deconstructed nanoporous material having the fire-retarding solution absorbed therein.

### Embodiment 22

The coating of any preceding embodiment, or any combination of preceding embodiments, further comprising a concentrate of the fire-retarding solution included within the deconstructed nanoporous material resulting from partial evaporation of liquid from the deconstructed nanoporous material having the fire-retarding solution absorbed therein.

### Embodiment 23

The coating of any preceding embodiment, or any combination of preceding embodiments, wherein the polymeric resin comprises a vinyl chloride resin, a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

### Embodiment 24

The coating of any preceding embodiment, or any combination of preceding embodiments, wherein the solids of the fire-retarding solution comprise crystalline solids resulting from evaporation of liquid from the fire-retarding solution.

### Embodiment 25

The coating of any preceding embodiment, or any combination of preceding embodiments, wherein the fire-retarding solution comprises a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

### Embodiment 26

The coating of any preceding embodiment, or any combination of preceding embodiments, wherein the deconstructed nanoporous material comprises a hydrophilic deconstructed nanoporous material.

### Embodiment 27

The coating of any preceding embodiment, or any combination of preceding embodiments, wherein the fire-retarding solution comprises one of an aqueous fire-retarding solution, a nontoxic liquid fire-retarding solution, and a neutral pH liquid fire-retarding solution.

### Embodiment 28

The coating of any preceding embodiment, or any combination of preceding embodiments, comprising a surfactant, a thickener, a pigment, a fiber, or a combination thereof incorporated into the polymeric resin.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

It will be appreciated that the summary herein is provided merely for purposes of summarizing some example aspects so as to provide a basic understanding of the disclosure. As such, it will be appreciated that the above described example aspects are merely examples and should not be construed to narrow the scope or spirit of the disclosure in any way. It will be appreciated that the scope of the disclosure encompasses many potential aspects, some of which will be further described below, in addition to those herein summarized. Further, other aspects and advantages of such aspects disclosed herein will become apparent from the following detailed description taken in conjunction with the accompanying drawings which illustrate, by way of example, the principles of the described aspects.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates a method of forming a coating, according to one aspect of the present disclosure; and

FIG. 2 schematically illustrates a method of forming a coating, according to another aspect of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

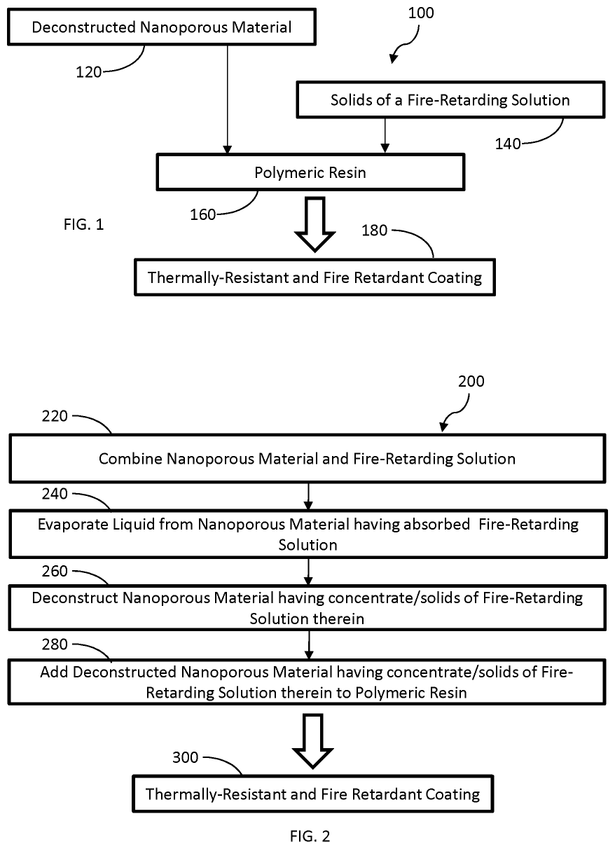

FIG. 1 schematically illustrates a method of forming a coating, the method being generally indicated by element 100. According to certain aspects of the disclosure, such a method includes adding a deconstructed nanoporous material 120 and solids of a fire-retarding solution 140 to a polymeric resin 160 lacking an intumescent material to form a thermally-insulating, fire-retardant coating 180 having a homogenous consistency. In some instances, the deconstructed nanoporous material 120 comprises a deconstructed silica-based or silicon dioxide-based nanoporous material. In other particular instances, the deconstructed nanoporous material 120 comprises a deconstructed silica (silicon dioxide) aerogel nanoporous material. An example of such a nanoporous material includes any commercially available amorphous silica (silicon dioxide) materials generally designated as an aerogel. In particular aspects of the disclosure, the polymeric resin 160 comprises a vinyl chloride resin. However, one skilled in the art will appreciate that the polymeric resin 160 can comprise or include many different compounds, particularly compounds that can be applied to a surface as a coating such as paint. In particular aspects, the choice of polymeric resin may depend on several factors, including the required heat resistance (e.g., temperature level and/or duration) of the resulting coating. More particularly, examples of suitable alternate polymeric resins implemented in connection with the present disclosure include a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof. In particular aspects of the present disclosure, the selected polymeric resin has a glass transition temperature in the range of between about −30° C. and about +25° C.

Non-limiting examples of suitable nanoporous materials implemented as the nanoporous material 120 in connection with the present disclosure can include Enersens Kwark® aerogel, Svenska Quartzene® Z1 aerogel, Cabot Enova® aerogel, and JIOS AeroVa® aerogel. In one instance, the nanoporous material 120 comprises, for example, NANOLIT® carbon aerogel and/or UNINANO TS-Powder® aerogel, which generally demonstrate high surface area and exhibit resistance to heat. Particularly, NANOLIT® has a surface area of between about 700 and about 1500 m²/g and a density of about 0.5 g/cc, while TS-Powder® has a surface area of between about 600 and about 1000 m²/g and a density of between about 0.06 and about 0.38 g/cc. Such example aerogels generally demonstrate a low thermal conductivity λ and do not absorb liquid water (hydrophobic), but are permeable to water vapor. Generally, such example aerogels do not include fungicides, algaecides, pesticides, binding agents, or flame retardants, and do not react with other materials. However, one skilled in the art will appreciate that the nanoporous material can comprise or include many different compounds, organic or inorganic (e.g., precipitated silica), which may be available under many different trade names.

The nanoporous material may be refined, as appropriate, in order to attain the deconstructed nanoporous material 120 disclosed herein in connection with the coating 180 and method of making the same. For example, the nanoporous material can be chopped, ground, or pulverized or otherwise subject to suitable processing to reduce and deconstruct larger elements of the nanoporous material into smaller elements having a desired level of refinement as reflected, for example, in an average particle size range. In a coating 180 according to aspects of the present disclosure, the nanoporous material, upon being deconstructed may desirably have an average element size within the range of between about 0.5 mm and about 1.5 mm. In some aspects of the present disclosure, very fine particles of the nanoporous material, typically an average element size of below about 0.1 mm, may also be added (e.g., in addition to the deconstructed nanoporous material), to fit within or provide packing in interstices between the larger sized particles of deconstructed nanoporous material. The nanoporous material may be deconstructed via mechanical processing such as, for example, through a hammermill or other suitable processing device.

In some aspects, the solids of the fire-retarding solution 140 can be obtained or produced by evaporating liquid from the fire-retarding solution, wherein the solids of the fire-retarding solution 140 will remain following the de-liquification process. According to particular aspects of the present disclosure, the fire-retarding solution comprises a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof. In addition, the fire-retarding solution may be implemented as one of an aqueous fire-retarding solution, a nontoxic liquid fire-retarding solution, and a neutral pH liquid fire-retarding solution. The evaporative process may include, for example, heating the fire-retarding solution to evaporate the liquid therefrom, until all that remains is the solids of the fire-retarding solution 140 (e.g. a precipitate, for example, in the form of a crystalline solid). Such a process may be similar to, for example, obtaining salt crystals by heating a salt solution such that the water in the solution evaporates and the salt crystals remain as the precipitate. In other instances, the evaporative process may include, for example, subjecting the fire-retarding solution to a spray drying procedure.

Once the solids of the fire-retarding solution 140 are obtained, the solids may be refined, as appropriate, in order to attain a suitable level of refinement as disclosed herein in connection with the coating and method of making the same. For example, the solids can be chopped, ground, or pulverized or otherwise subject to suitable processing to reduce and deconstruct larger elements of the solids into smaller elements having a desired level of refinement as reflected, for example, in an average particle size range. In a coating according to aspects of the present disclosure, the solids, upon being deconstructed may desirably have an average element size of no greater than the average element size of the deconstructed nanoporous material (e.g., between about 0.5 mm and about 1.5 mm). In some aspects of the present disclosure, it may be desirable for the solids of the fire-retarding solution to be very fine particles, with an average element size of below about 0.1 mm. The solids may be deconstructed/refined via mechanical processing such as, for example, through a hammermill or other suitable processing device.

The deconstructed nanoporous material 120 and the solids of the fire-retarding solution 140 can subsequently be combined with the polymeric resin 160 to form a thermally-insulating, fire-retardant coating 180 having a homogenous consistency. That is, the deconstructed nanoporous material 120 and the solids of the fire-retarding solution 140 can be added to the polymeric resin 160 in sufficient quantities and dispersed substantially uniformly therethrough such that the coating 180 exhibits a homogenous or uniform consistency, with the coating 180 appearing smooth when applied to a surface. Even if the nanoporous material (e.g., NANOLIT®) is hydrophobic, whether as-manufactured or by post-manufacturing treatment, the nanoporous material is not required (but can be, if desired) to be rendered hydrophilic prior to being combined with the solids of the fire-retarding solution 140 and the polymeric resin 160.

The insulating properties of the nanoporous material, as well as the flame/fire resistance afforded to the nanoporous material and the polymeric resin by the solids of the fire-retarding solution 140, thus obviate the need for other fire-retarding provisions in the coating 180, such as, for example, intumescent materials. However, in some aspects, an intumescent material/element may be added/included in addition to (but not instead of), the solids of the fire-retarding solution as disclosed herein. The resulting coating 180, in certain aspects of the present disclosure, thus generally lacks an intumescent material component, particularly as the specified solids of the fire-retarding solution and therefore is normally designated as a non-intumescent coating. Further, the insulating properties of the nanoporous material impart a significant as-applied insulation value to the resulting coating 180 (e.g., a passive or ambient insulation value) as compared, for example, to an intumescent coating which generally only provides any insulation value of significance when actuated/activated. For example, a single coat or layer of the coating according to aspects of the present disclosure, may have a thickness of between about 2 mm and about 5 mm (in general, the coating may have a single coat thickness of between about 0.5 mm and about 10 mm), can exhibit an insulation “R-value” when applied and cured (e.g., a passive or ambient insulation value). This as-applied insulation value of the coating according to aspects of the present disclosure will be greater than a comparable thickness (e.g., between 1 mm and 10 mm) of a conventional intumescent coating. Further, the conventional intumescent coating, upon application to a surface, generally results in a rough or textured coating on that surface.

When exposed to fire/flame at temperatures of between about 200° C. and about 250° C., representing the activation temperature of a typical intumescent material, a conventional intumescent coating having a 1 mm application thickness, will expand to about a 40 mm thick layer. In so expanding in response to heat/flame, the convention intumescent coating will provide a thermal barrier for the underlying coated surface. However, the resin matrix supporting the intumescent particles/material may not necessarily be fire-retardant, which may, in some instances, limit the fire-retarding performance of intumescent coatings. In comparison, though the nanoporous material and the polymeric resin implemented in coatings according to the present disclosure may not necessarily be fire-retardant, the implementation and inclusion of the solids of the fire-retarding solution will impart a fire-retarding property to both the nanoporous material and the polymeric resin components of the coating. As such, though both a coating according to aspects of the present disclosure and a conventional intumescent coating will provide thermal protection in the event that the coating is exposed to fire/flame, thermal protection of the underlying surface and fire-resistance of the coating will be greater for a coating according to aspects of the present disclosure in comparison to conventional intumescent coatings.

One skilled the art will further appreciate that other elements such as, for example, a surfactant, a thickener, a pigment, a fiber, or a combination thereof may also be added to the polymeric resin, as necessary or desired, for the properties and purposes exhibited by those additional elements. In some particular aspects of the present disclosure, the polymeric resin comprises between about 30 weight percent and about 80 weight percent of the overall coating composition.

In another aspect of the present disclosure, as shown in FIG. 2, instead of the deconstructed nanoporous material 120 and the solids of the fire-retarding solution 140 being combined with the polymeric resin 160 as shown in FIG. 1, the nanoporous material and the fire-retarding solution may first be combined such that the nanoporous material absorbs the liquid fire retarding solution (block 220). The nanoporous material may or may not be deconstructed/refined prior to the combination with the fire-retarding solution. Once absorbed or otherwise combined for a sufficient time to permit absorption, the liquid is evaporated from the nanoporous material having the fire-retarding solution absorbed therein (block 240) such that a concentrate of the fire-retarding solution and/or the solids thereof remain within the nanoporous material.

One skilled in the art will appreciate that the liquid can be evaporated from the nanoporous material having the fire-retarding solution absorbed therein, in different appropriate manners. For example, the nanoporous material having the fire-retarding solution absorbed therein may be heated to evaporate the liquid. In other instances, the nanoporous material having the fire-retarding solution absorbed therein may have the liquid evaporated therefrom by subjecting the saturated nanoporous material to a heating process, a spray drying process, and/or any other suitable process to remove at least some of the liquid from the fire-retarding solution absorbed by the nanoporous material. That is, it may be sufficient to evaporate at least a portion or particular amount of the liquid from the fire-retarding solution such that the precipitates of the increasingly-concentrated (less liquid) fire-retarding solution, a more highly-concentrated fire-retarding solution, and/or solids of the fire-retarding solution sufficiently remain within the pores or otherwise remain engaged with a surface of the nanoporous material. As previously disclosed, the fire-retarding solution combined with and absorbed by the nanoporous material may comprise a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

In some aspects, prior to combining the nanoporous material and the fire-retarding solution, is may be necessary or desirable to first treat the nanoporous material to render the nanoporous material hydrophilic. That is, the nanoporous material (e.g., NANOLIT®) may be hydrophobic as-produced, or may be hydrophobic as a result of a post-manufacturing treatment applied thereto by the manufacturer (e.g., made hydrophobic through the use of a silylating agent), for example, to prevent the nanoporous material from absorbing moisture from the immediate environment. Accordingly, prior to being implemented as disclosed herein, particularly in instances where the liquid fire-retarding solution is absorbed by the nanoporous material, the nanoporous material may be first treated to render the nanoporous material hydrophilic. More particularly, in some instances, an example silylating agent used to render the hydrophilic nanoporous material hydrophobic is trimethylchlorosilane (TMCS), having a boiling point of 57° C. In order to remove the TMCS and/or any other silylating agents from the treated (hydrophobic) nanoporous material, for example, the treated nanoporous material may be placed in a forced (air) circulating oven and heated to approximately 10° C. under the boiling point of the silylating agent used to render the nanoporous material hydrophobic (e.g., heat the hydrophobic nanoporous material to a certain temperature associated with the boiling point of the silylating agent, but without sintering the nanoporous material).

Once the hydrophilic nanoporous material having the fire-retarding solution absorbed therein is processed to remove (e.g., evaporate or de-liquify) a sufficient amount of the liquid associated with the fire-retarding solution, the nanoporous material having the concentrates and/or solids of the fire-retarding solution therein may be deconstructed/refined (block 260), as appropriate, in order to attain a suitable level of refinement as disclosed herein in connection with the coating and method of making the same. For example, the nanoporous material having the concentrates and/or solids of the fire-retarding solution therein can be chopped, ground, or pulverized or otherwise subject to suitable processing to reduce and deconstruct/refine larger elements thereof into smaller elements having a desired level of refinement as reflected, for example, in an average particle size range. In a coating according to aspects of the present disclosure, the nanoporous material having the concentrates and/or solids of the fire-retarding solution therein, upon being deconstructed may desirably have an average element size within the range of between about 0.5 mm and about 1.5 mm. In some aspects of the present disclosure, very fine particles of the nanoporous material having the concentrates and/or solids of the fire-retarding solution therein, typically an average element size of below about 0.1 mm, may also be added (e.g., in addition to the deconstructed nanoporous material having the concentrates and/or solids of the fire-retarding solution therein), to fit within or provide packing in interstices between the larger sized particles of deconstructed nanoporous material having the concentrates and/or solids of the fire-retarding solution therein. The nanoporous material having the concentrates and/or solids of the fire-retarding solution therein may be deconstructed/refined via mechanical processing such as, for example, through a hammermill or other suitable processing device.

The refined and deconstructed nanoporous material having the concentrates and/or solids of the fire-retarding solution therein can subsequently be combined with the polymeric resin (block 280) to form a thermally-insulating, fire-retardant coating 300 having a homogenous consistency, as otherwise disclosed herein. That is, the refined and deconstructed nanoporous material having the concentrates and/or solids of the fire-retarding solution therein can be added to the polymeric resin in a sufficient quantity and dispersed substantially uniformly therethrough such that the coating exhibits a homogenous or uniform consistency, with the coating appearing smooth when applied to a surface. The insulating properties of the nanoporous material, as well as the flame/fire resistance afforded to the nanoporous material and the polymeric resin (e.g., by the concentrates and/or solids of the fire-retarding solution leaching from the nanoporous material and into the polymeric resin, upon the deconstructed nanoporous material having the concentrates and/or solids of the fire-retarding solution therein being added to or combined with the polymeric resin), thus obviates the need for other fire-retarding provisions in the coating, such as, for example, intumescent materials. Accordingly, the resulting coating, according to particular aspects of the present disclosure, lacks an intumescent material component, and therefore can be designated as a non-intumescent coating. Further, the insulating properties of the nanoporous material impart a significant insulation value to the resulting coating as compared, for example, to an intumescent coating, as otherwise disclosed herein, while providing a comparatively smooth coating in relation to, for example, an intumescent coating. In addition, as also otherwise disclosed herein, one skilled the art will further appreciate that other elements such as, for example, a surfactant, a thickener, a pigment, a fiber, or a combination thereof may also be added to the polymeric resin, as necessary or desired, for the properties and purposes exhibited by those additional elements. In some particular aspects of the present disclosure, the polymeric resin comprises between about 30 weight percent and about 80 weight percent of the overall coating composition.

One aspect of the present disclosure thus provides a coating, comprising a polymeric resin lacking an intumescent material, a deconstructed nanoporous material, and solids of a fire-retarding solution, wherein the deconstructed nanoporous material and the solids of the fire-retarding solution are incorporated into the polymeric resin to form a thermally-insulating, fire-retardant coating having a homogenous consistency. The deconstructed nanoporous material can comprise a deconstructed silica-based nanoporous material and, more particularly, a deconstructed silica aerogel nanoporous material. The polymeric resin can comprise a vinyl chloride resin or other suitable resin material, such as a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

The solids of the fire-retarding solution comprise crystalline solids resulting from evaporation of liquid from the fire-retarding solution. Such a fire-retarding solution can comprise a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

In some aspects, the deconstructed nanoporous material and the solids of the fire-retarding solution are separately processed before being combined in the polymeric resin. In other aspects, the solids of the fire-retarding solution and/or a concentrate of the fire-retarding solution are included within the nanoporous material (with deconstruction of the nanoporous material being performed prior to the combination with the fire-retarding solution, or with deconstruction being performed on the combination) and result from evaporation of liquid from the nanoporous material having the fire-retarding solution absorbed therein. In order for the fire-retarding solution to be absorbed, the nanoporous material comprises a hydrophilic nanoporous material. Moreover, upon formation of the coating, one or more of a surfactant, a thickener, a pigment, a fiber, or a combination thereof can be incorporated into the polymeric resin, as necessary or desired. In some particular aspects of the present disclosure, the polymeric resin comprises between about 30 weight percent and about 80 weight percent of the overall coating composition.

As such, aspects of the present disclosure provide a coating/paint capable of providing a significant insulation property in both a fire-exposure and ambient temperature situations by way of the nanoporous material. Moreover, the inclusion of the fire-retardant solution and/or solids of the fire-retarding solution impart fire-retarding property to both the nanoporous material, as well as the polymeric resin, most of which are not fire-resistant. The heat resistance of the coating may depend on the selection of the particular polymeric resin on which the coating is based. Generally, the nanoporous material, the element(s) of the fire-retarding solution and the polymeric resin are mixed together until a smooth paste or viscous liquid is obtained as the resulting coating. The resulting thermally-insulating and fire-retardant coating (without an intumescent element) can be applied via brush, spray, roller or the like. The coating/paint could be applied, for example, to masonry, plasterboard, or wooden surfaces, or steel structural columns or surfaces, particularly for a smooth aesthetic appearance of the coated surface.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

That which is claimed:

1. A method of forming a coating, comprising:
adding a deconstructed nanoporous material and solids of a fire-retarding solution to a polymeric resin lacking an intumescent material to form a thermally-insulating, fire-retardant coating having a homogenous consistency.

2. The method of claim 1, wherein adding the deconstructed nanoporous material and the solids of a fire-retarding solution to the polymeric resin comprises adding a deconstructed silica-based nanoporous material and the solids of the fire-retarding solution to the polymeric resin.

3. The method of claim 1, wherein adding the deconstructed nanoporous material and the solids of a fire-retarding solution to the polymeric resin comprises adding a deconstructed silica aerogel nanoporous material and the solids of the fire-retarding solution to the polymeric resin.

4. The method of claim 1, wherein adding the deconstructed nanoporous material and the solids of a fire-retarding solution to the polymeric resin comprises adding the deconstructed nanoporous material and the solids of the fire-retarding solution to a vinyl chloride resin, a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

5. The method of claim 1, comprising evaporating liquid from the fire-retarding solution to form the solids of the fire-retarding solution.

6. The method of claim 5, wherein evaporating liquid from the fire-retarding solution comprises spray drying the fire-retarding solution.

7. The method of claim 5, wherein evaporating liquid from the fire-retarding solution comprises evaporating liquid from the fire-retarding solution comprising a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

8. The method of claim 1, comprising treating the deconstructed nanoporous material to render the deconstructed nanoporous material hydrophilic, prior to adding the deconstructed nanoporous material and the solids of the fire-retarding solution to the polymeric resin.

9. The method of claim 1, comprising adding a surfactant, a thickener, a pigment, a fiber, or a combination thereof to the polymeric resin.

10. A method of forming a coating, comprising:
combining a nanoporous material and a fire-retarding solution such that the nanoporous material absorbs the fire retarding solution;
evaporating liquid from the nanoporous material having the fire-retarding solution absorbed therein such that a concentrate or solids thereof remain within the nanoporous material; and
adding the nanoporous material having the concentrate or solids of the fire-retarding solution therein to a polymeric resin lacking an intumescent material to form a thermally-insulating, fire-retardant coating having a homogenous consistency.

11. The method of claim 10, wherein combining the nanoporous material and the fire-retarding solution comprises combining a silica-based nanoporous material and the fire-retarding solution.

12. The method of claim 10, wherein combining the nanoporous material and the fire-retarding solution comprises combining a silica aerogel nanoporous material and the fire-retarding solution.

13. The method of claim 10, wherein combining the nanoporous material and the fire-retarding solution comprises combining the nanoporous material and the fire-retarding solution comprising a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

14. The method of claim 10, wherein evaporating liquid from the nanoporous material having the fire-retarding solution absorbed therein comprises spray drying the fire-retarding solution.

15. The method of claim 10, comprising treating the nanoporous material to render the nanoporous material hydrophilic, prior to combining the nanoporous material and the fire-retarding solution.

16. The method of claim 10, wherein adding the nanoporous material having the concentrate or solids of the fire-retarding solution therein to a polymeric resin comprises adding the nanoporous material having the concentrate or solids of the fire-retarding solution therein to a vinyl chloride resin, a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

17. The method of claim 10, comprising adding a surfactant, a thickener, a pigment, a fiber, or a combination thereof to the polymeric resin.

18. A coating, comprising:
a polymeric resin lacking an intumescent material;
a deconstructed nanoporous material; and
solids of a fire-retarding solution, the deconstructed nanoporous material and the solids of the fire-retarding solution being incorporated into the polymeric resin to form a thermally-insulating, fire-retardant coating having a homogenous consistency.

19. The coating of claim 18, wherein the deconstructed nanoporous material comprises a deconstructed silica-based nanoporous material.

20. The coating of claim 18, wherein the deconstructed nanoporous material comprises a deconstructed silica aerogel nanoporous material.

21. The coating of claim 18, wherein the solids of the fire-retarding solution are included within the deconstructed nanoporous material and result from evaporation of liquid from the deconstructed nanoporous material having the fire-retarding solution absorbed therein.

22. The coating of claim 21, further comprising a concentrate of the fire-retarding solution included within the deconstructed nanoporous material resulting from partial of liquid from the deconstructed nanoporous material having the fire-retarding solution absorbed therein.

23. The coating of claim 18, wherein the polymeric resin comprises a vinyl chloride resin, a vinyl acetate ethylene copolymer resin, a styrene-acrylic resin, an acrylic resin, a polyurethane resin, a silicone resin, an epoxy resin, a butadiene resin, a vinyl acrylate resin, a silicate resin, a vinyl acetate-butylacrylate copolymer resin, a carboxylated polymer resin, a polyvinylidene fluoride polymer resin, or combinations thereof.

24. The coating of claim 18, wherein the solids of the fire-retarding solution comprise crystalline solids resulting from evaporation of liquid from the fire-retarding solution.

25. The coating of claim 18, wherein the fire-retarding solution comprises a boron compound, a phosphorus compound, a chlorine compound, a lithium compound, a fluorine compound, an antimony compound, a borate compound, boric acid, an inorganic hydrate, a bromine compound, an aluminum compound, magnesium hydroxide, a phosphonium salt, a zirconium salt, ammonium phosphate, diammonium phosphate, methyl bromide, methyl iodide, bromochlorodifluoromethane, dibromotetrafluoroethane, dibromodifluoromethane, urea, or combinations thereof.

26. The coating of claim 18, wherein the deconstructed nanoporous material comprises a hydrophilic deconstructed nanoporous material.

27. The coating of claim 18, wherein the fire-retarding solution comprises one of an aqueous fire-retarding solution, a nontoxic liquid fire-retarding solution, and a neutral pH liquid fire-retarding solution.

28. The coating of claim 18, comprising a surfactant, a thickener, a pigment, a fiber, or a combination thereof incorporated into the polymeric resin.
